(19) United States
(12) Patent Application Publication
(10) Pub. No.: US 2005/0125666 A1
(43) Pub. Date: Jun. 9, 2005

(54) Method of using an electronic seal for inserting an electronic seal into contents of a document in a computer system

(76) Inventor: Shu-Ming Lin, Taipei (TW)

Correspondence Address: BACON & THOMAS, PLLC, 625 SLATERS LANE, FOURTH FLOOR, ALEXANDRIA, VA, 22314, US

(21) Appl. No.: 10/728,975

(22) Filed: Dec. 8, 2003

(51) Int. Cl. H04L 9/00

(52) U.S. Cl. 713/170

(57) ABSTRACT

A method of using an electronic key for inserting an electronic seal into contents of a document in a computer system, whereby the electronic key is provided with a memory, and the computer system comprises a storage device and an add-in program. The method includes: (a) inserting the electronic key into the computer system, then utilizing the add-in program to define the electronic seal and generate a corresponding random number, and storing the random number into the storage device and the memory; (b) utilizing the add-in program to insert the electronic seal into the contents of the document and generate attributes of the document, thereat inserting the attributes of the document into the contents of the document.

### BACKGROUND OF THE INVENTION

(a) Field of the Invention

The present invention relates to a method of using a first electronic key for inserting an electronic seal into contents of a document in a computer system, and more particularly to the first electronic key being provided with a memory, which is utilized to store a random number, and the computer system comprises a storage device and an add-in program. The electronic key is inserted into the computer system, and the add-in program defines the electronic seal and generates a corresponding random number, and thereafter stores the random number into the storage device and the memory. The add-in program can then insert the electronic seal into the contents of the document, and attributes of the document are then generated and inserted into the contents of the document.

(b) Description of the Prior Art

With increasing frequency of interactive dealings between people including business contracts, governmental documentation, and so on, signing of documents and authentication of such has become a crucial link in intercourse and retaining of the documents. In eastern society, in addition to a signature of a person, a seal is also an essential record of authentication, and on many documents requiring authentication, the seal has become a sole criterion of verification. However, following refinement of counterfeit techniques, many forged seals are difficult to identify at first sight, even for professionals, much less general public, and results in a quandary regarding usage of the traditional seal.

In recent years, because electronic technologies have permeated into livelihoods of populace, exchange of many documents is already implemented through paperless electronic transfer. However, when a photocopy is required of the electronic document, usually the electronic document is first printed out and then stamped with a traditional seal, and thereafter the document is scanned in order to produce another electronic document that can be transmitted to next contracting party, fruitlessly wasting time and money.

Thus, there is a need to resolve problems of evading difficulties in identification of the traditional seal and averting aggravation when printing is required of the electronic documents, while equally supporting advantages of the traditional seal and the electronic document.

### SUMMARY OF THE INVENTION

The present invention relates to a computer system utilizing a portable electronic key and add-in program software to produce an electronic seal and execute authentication of the electronic seal. In addition, the electronic key has features including easy connection to a computer, and convenience of portability. Thus employment of the electronic key realizes replacement of a traditional seal. Even if the electronic key is stolen, if a person who stole the electronic key does not know identity and password of an owner of the electronic key, then it is impossible for the person who stole the electronic key to successfully pass identity validation procedures, and therefore impossible for the person who stole the electronic key to use the electronic key. This provides the electronic key with greater security than the traditional seal. Furthermore, because the electronic key must be connected to the computer in order to function, a hand of the user will not become tainted with ink from an inkpad as would result if a traditional seal was used. Moreover, the computer confirms validity of the electronic seal rather than pure identification with the naked eye. As counterfeit techniques change with each passing day, falsification of the traditional seal will remain much easier compared to that of the electronic seal, therefore the electronic key is able to safeguard rights and interests of the user.

Accordingly, an objective of the present invention is to allow the user to insert the personal electron seal into the document, which then acts as a reference for future document identity authentication.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a computer system according to the present invention.

FIG. 2 shows a schematic view of an electronic seal according to the present invention.

FIG. 3 shows a schematic view of an image produced by a random number according to the present invention.

FIG. 4 shows a schematic view of an electronic key according to the present invention.

### DETAILED DESCRIPTION OF THE PREFERRED EMBODIMENTS

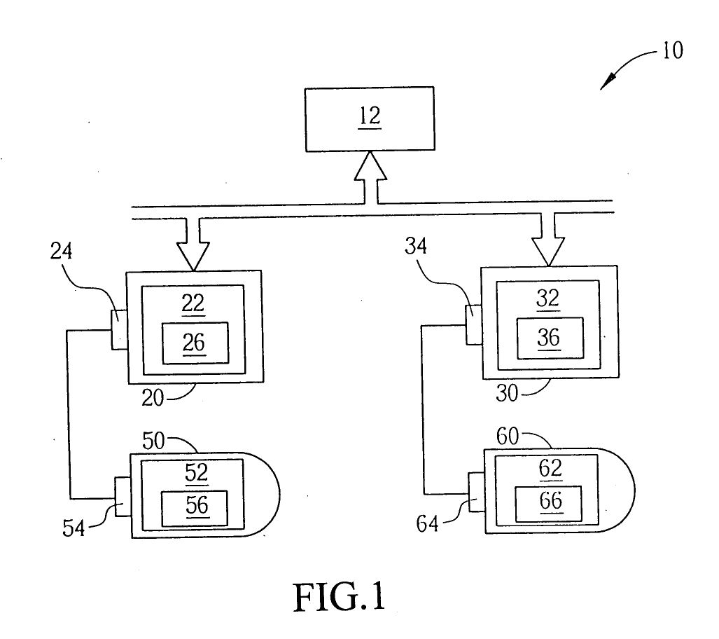

Referring to FIG. 1, which shows a computer system 10 comprising a storage device 12, a plurality of computers 20, 30, which are mutually connected via a network, and a plurality of portable electronic keys 50, 60. The computers 20 and 30 are each provided with a memory 22 and 32 respectively, which are utilized to store a program and data therein. Input ports 24 and 34, and add-in programs 26 and 36 are stored in the memories 22 and 32 respectively. The electronic keys 50, 60 are each provided with an electrically erasable programmable read only memory (EEPROM) 52 and 62 respectively, which are utilized to store random numbers 56 and 66 respectively. Key ports 54 and 64 are utilized to mutually connect with the input ports 24 and 34 respectively by means of a removably insertable method. The Key ports 54 and 64 can be configured as Universal Serial Bus (USB) ports, RS-232 ports or other peripheral interfaces.

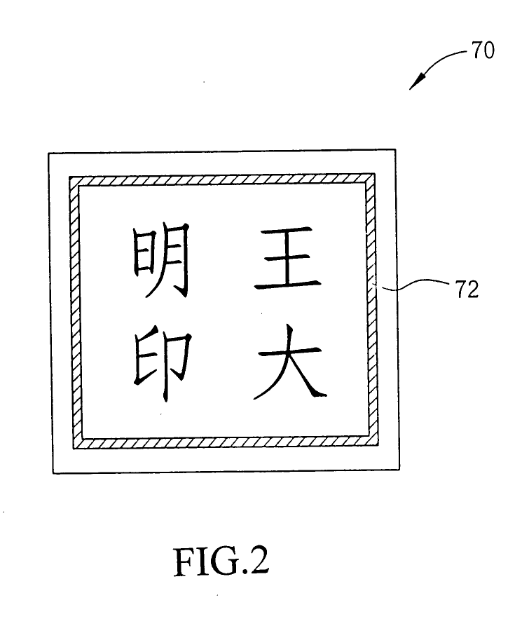

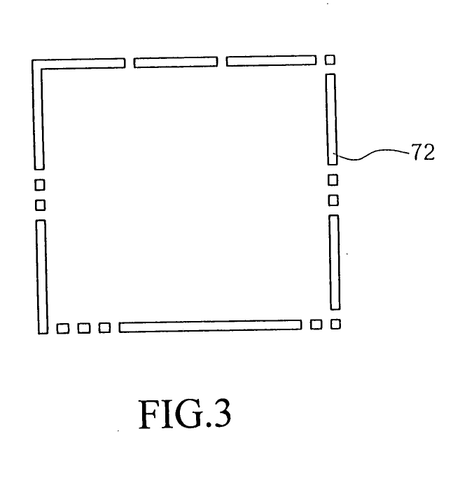

Referring to FIGS. 2 and 3, upon a user connecting the key port 54 of the electronic key 50 to the input port 24 of the computer 20, in accordance with identity and password entered by the user, the computer 20 implements identity validation procedures in order to prevent misappropriation of the electronic key 50, thereupon the add-in program 26 produces an image 72 of an electronic seal 70 based on characteristics of the user stored within the memory 52 including full name of the user, color, font, size, and so on. In addition, the aforementioned characteristics are recorded using binary digits “0” and “1”, for example, a red font can be registered as “0000”, a blue font can be registered as “0110”, and so on. Thereafter, the add-in program 26 generates a scrambled number, which is then combined with the characteristics of the electronic seal 70 to form the random number 56. Moreover, the random number 56 is simultaneously stored within the storage device 12 and the memory 52 of the electronic key 50. In addition, the image 72 as generated by the random number 56 will display on the electronic seal 70. In such an embodiment, as FIG. 3 depicts, the image 72 so displayed consists of a bar code made up from different lengths.

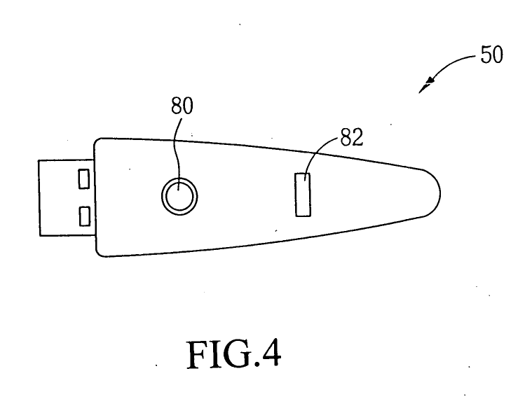

Referring to FIG. 4, which depicts the electronic key 50 provided with a key 80, and upon touching the key 80 the electronic seal 70 is inserted into contents of the document in the computer. However, apart from inserting the electronic seal 70 into the document by means of the key 80, the user can also insert the electronic seal 70 by touching a user interface of the computer 20. The electronic key 50 is further configured with an indicator 82, where upon an abnormality occurring with the electronic key 50, the indicator will thus flash thereby informing the user that the electronic key 50 is proceeding with a particular process or requires servicing.

After the user has inserted the electronic seal 70 into the computer document, the user can lock the document thereby preventing modification of the contents of the document. Finally, the document within which the electronic seal 70 has been already inserted, together with the contents of the document and attributes of the document are stored in the storage device 12, where the attributes of the document consist of those produced by the add-in program 26. The attributes of the document can include time of inserting the electronic seal 70, a stamp mark, position, and angle of the electronic seal 70, the user identity, time when the document was closed, time when the document was modified, and so on.

After the user has locked the document, if the user wants to examine the document again the user must reinsert the key port 54 of the electronic key 50 into the input port 24 of the computer 20, whereupon the computer 20 proceeds with identity validation procedures according to the identity and password of the user, thereby confirming whether or not the electronic key 50 is that of a key of the inserted electronic seal 70. If the electronic key 50 is that of the key of the inserted electronic seal 70 then the computer system 10 proceeds with matching the random number 56 retrieved from the memory 52 of the electronic key 50 to that of the random number 56 stored within the storage device 12. If the random number 56 retrieved from the memory 52 of the electronic key 50 corresponds with that of the random number 56 stored within the storage device 12 then the document can be opened. Moreover, the user can unlock the document and proceed with modifying or attaching another document to the document. If the random number 56 retrieved from the memory 52 of the electronic key 50 does not correspond with that of the random number 56 stored within the storage device 12, then the document cannot be opened, thereby preventing confidential documents from leaking out. In another embodiment of the present invention, even though the random number 56 retrieved from the memory 52 of the electronic key 50 does not correspond with that of the random number 56 stored within the storage device 12, the document can still be opened but the user cannot unlock the document, and therefore is impossible to make any modifications to the document. Moreover, the user is not able to attach another document to the document.

After the computer 20 has undertaken identity validation procedures, and upon the computer 20 confirming that the electronic key is not that of the key of the electronic seal 70 but is that another electronic key 60, the computer 20 checks extent of authority of the electronic key 60. If the electronic key 60 is only provided with the extent of authority to open the document, then the document can be opened and the user of the electronic key 60 can attach another document to the document provided with the electronic seal 70. The user of the electronic key 60 is able to insert another electronic seal in the attached document, and thereby signalize the identity of the user of the attached document. Furthermore, because the computers 20 and 30 are mutually connected via the Internet, in addition to re-inspecting the documents provided with the electronic seal 70 via the computer 20, the user is also able to re-inspect the documents provided with the electronic seal 70 via the computer 30, as well as being able to add to the attached documents and inserting another electronic seal via the computer 30.

Because the storage device 12 stores attributes of the locked document, upon the user reopening the document, the user is able to discern whether the document has been previously opened or modified by examining the attributes of the document. In addition, because the electronic seal 70 is provided with the image 72 based on the random number 56, the user is also able to examine the image 72 to judge whether or not the electronic seal 70 has been unlawfully entered.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A method of using a first electronic key for inserting an electronic seal into contents of a document in a computer system, whereby the first electronic key comprises a memory, which is utilized to store a random number, and the computer system comprises a storage device and an add-in program; the method includes steps of:
(a) inserting the first electronic key into the computer system, then utilizing the add-in program to define the electronic seal and generate a corresponding random number, and storing the random number into the storage device and the memory;
(b) utilizing the add-in program to insert the electronic seal into the contents of the document and generate attributes of the document, and inserting the attributes of the document into the contents of the document.

2. The method of using a first electronic key for inserting an electronic seal into contents of a document in a computer system according to claim 1, wherein the random number is generated according to characteristics of the electronic seal and a scrambled number.

3. The method of using a first electronic key for inserting an electronic seal into contents of a document in a computer system according to claim 1, wherein the electronic seal is amended in accordance with the random number, and thereby stored in the storage device, and the electronic seal inserted into the contents of the document is provided with an image generated by the random number.

4. The method of using a first electronic key for inserting an electronic seal into contents of a document in a computer system according to claim 1, wherein prior to implementing step (a), in accordance with identity and password entered by a user, the computer system implements identity validation procedures in order to prevent misappropriation of the first electronic key.

5. The method of using a first electronic key for inserting an electronic seal into contents of a document in a computer system according to claim 1, wherein after implementing step (b), the first electronic key is once again inserted into the computer system, and a verification procedure is implemented to verify whether or not the random number stored within the storage device is consistent with the random number stored within the memory.

6. The method of using a first electronic key for inserting an electronic seal into contents of a document in a computer system according to claim 1, wherein after implementing step (b), the first electronic key is once again inserted into the computer system, and opens attributes of the document, thereby enabling the user to view status of the document.

7. The method of using a first electronic key for inserting an electronic seal into contents of a document in a computer system according to claim 1, wherein after implementing step (b) the document can be locked thereby preventing modification of the contents of the document.

8. The method of using a first electronic key for inserting an electronic seal into contents of a document in a computer system according to claim 1, wherein after implementing step (b), a second electronic key is inserted into the computer system, and the computer system checks extent of authority of the second electronic key, and thereby determines whether or not the second electronic key is provided with the authority to open the document, if the second electronic key is provided with the extent of authority to open the document, then additional documents can be attached to the document.

9. The method of using a first electronic key for inserting an electronic seal into contents of a document in a computer system according to claim 1, wherein the first electronic key is provided with a key, and upon touching the key the electronic seal is inserted into the contents of the document.

10. The method of using a first electronic key for inserting an electronic seal into contents of a document in a computer system according to claim 1, wherein the electronic seal can be inserted into the contents of the document through a user interface of the computer system.

11. The method of using a first electronic key for inserting an electronic seal into contents of a document in a computer system according to claim 1, wherein the memory is electrically erasable programmable read only memory (EEPROM).

12. The method of using a first electronic key for inserting an electronic seal into contents of a document in a computer system according to claim 1, wherein the first electronic key is connected to the computer system through a Universal Serial Bus port.

13. The method of using a first electronic key for inserting an electronic seal into contents of a document in a computer system according to claim 1, wherein the first electronic key is connected to the computer system through a RS-232 port.
